(19) United States
(12) Patent Application Publication
(10) Pub. No.: US 2008/0315118 A1
(43) Pub. Date: Dec. 25, 2008

(54) FLUORESCENCE MEASUREMENT PROBE

(75) Inventors: Ryo Anraku, Tokyo (JP); Takashi Fukuzawa, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NIPPON SHEET GLASS COMPANY, LIMITED, Tokyo (JP)

(21) Appl. No.: 12/140,407

(22) Filed: Jun. 17, 2008

(30) Foreign Application Priority Data
Jun. 19, 2007 (JP) 2007-161666

(51) Int. Cl. G01J 1/58

(52) U.S. Cl. 250/458.1

(57) ABSTRACT

A fluorescence measurement probe capable of stably receiving a maximum received light amount of a fluorescent light generated from a specimen onto which an excitation light is radiated. The fluorescence measurement probe is applied to a fluorescence measurement system provided with an optical system. A light source emits an excitation light. A detector receives the fluorescent light. A solid light guide path serves as an optical path of the excitation light as well as the fluorescent light. A lens is disposed between an edge surface of the solid light guide path and the specimen. When a radiation angle of the excitation light is set to 2θ at a position where the excitation light is collected by the lens which collects the fluorescent light. A excitation light beam NA expressed by sin θ is set to 0.14 or more and 0.31 or less.

### BACKGROUND OF THE INVENTION

1. Field of the Invention

The present invention relates to a fluorescence measurement probe, and more particularly, relates to a fluorescence measurement probe applied to a fluorescence measurement system provided with an optical system having a solid light guide path where an optical path of an excitation light is the same as an optical path of a fluorescent light received from a specimen.

2. Description of the Related Art

Examples of a system for performing a chemical reaction in a microspace includes a microchemical system. The microchemical system performs a mixture, a reaction, a separation, an extraction, a detection or the like of a specimen in a micro flow channel formed on a small glass substrate and the like.

In such a microchemical system, various kinds of optical measurement methods have often been used for detecting a small amount of material in a micro area such as a microwell, a microchemical chip, and a microcapillary. Examples thereof include a thermal lens spectrometry, a fluorescence detection and the like. As the fluorescence detection, there has recently been proposed a fluorescence measurement system using an optical fiber to provide a solid light guide path (e.g., an optical fiber, a waveguide, and the like) which guides an excitation light and a fluorescent light received from a specimen through the same optical path (see Japanese Laid-Open Patent Publication (Kokai) No. 2005-030830).

FIG. 17 is a block diagram showing a configuration of a conventional fluorescence measurement system.

With reference to FIG. 17, the fluorescence measurement system is comprised mainly of a light source 41 for an excitation light generating an excitation light to be radiated onto a specimen; an optical multiplexer/demultiplexer 42 reflecting the excitation light radiated from the light source 41 and radiating the excitation light through a probe 43 onto the specimen on a fluorescence analysis chip 44 as well as passing the fluorescent light from the specimen; and a detector 45 receiving the fluorescent light passed through the optical multiplexer/demultiplexer 42. Every component members are connected with each other, for example, by an optical fiber.

The probe 43 receives the excitation light emitted from the light source 41, radiates the excitation light beam onto the specimen through a lens from an edge surface of the optical fiber serving as the solid light guide path, and collects the fluorescent light generated from the specimen receiving the radiated excitation light. Here, the lens placed between the edge surface of the optical fiber and the specimen may be a single lens or a combined lens.

The probe 43 uses the same lens and the same light guide path to radiate an excitation light onto a specimen and collect the fluorescent light generated from the specimen, which allows position adjustment of the probe and the specimen for excitation light radiation and fluorescent light collection to be performed at the same time. Accordingly, measurement in a micro area can be facilitated as well as a confocal optical system can be constructed by using the core of an optical fiber as a pinhole. This increases the spatial resolution, which assures an accurate measurement in a micro area.

In a microchemical system performing measurement in a micro area, an optimum excitation light radiation angle and a fluorescent light fetching angle are considered to be different depending on the type of a lens used in the probe, the thickness of a specimen, and the like. For that reason, it can be considered that designing a fluorescence measurement probe having an optical system suitable for the type of the lens, the thickness of the specimen, and the like causes the fluorescent light receiving efficiency to increase, and this can increase the detection sensitivity, but no example of designing described above resulting in success has been reported yet.

In addition, the optical system for a microchemical system has a short optical path, i.e., a large signal change with respect to a positional misalignment of the specimen, and thus has a problem in that measured values are not stable.

### SUMMARY OF THE INVENTION

The present invention provides a fluorescence measurement probe capable of stably receiving a maximum received light amount of fluorescent light generated from a specimen onto which an excitation light is radiated.

Accordingly, in the present invention, there is provided a fluorescence measurement probe which is applied to a fluorescence measurement system provided with an optical system having a light source emitting an excitation light and a detector receiving a fluorescent light generated from a specimen onto which the excitation light is radiated, comprising a solid light guide path adopted to serve as an optical path of the excitation light as well as an optical path of the fluorescent light, a lens disposed between an edge surface of the solid light guide path and the specimen, wherein when a radiation angle of the excitation light is set to 2θ at a position where the excitation light is collected by the lens which collects the fluorescent light generated from the specimen receiving the excitation light which is emitted from the solid light guide path and radiated through the lens, an excitation light beam NA expressed by sin θ is set to 0.14 or more and 0.31 or less.

According to the present invention, when the radiation angle of the excitation light is set to 2θ at the position where the excitation light is collected by the lens which collects the fluorescent light generated from the specimen onto which the excitation light is radiated through the lens, the excitation light beam NA expressed by sin θ is set to 0.14 or more and 0.31 or less. Accordingly, the maximum received light amount can be stably received and the measurement sensitivity is increased.

The present invention can provide a fluorescence measurement probe, wherein the excitation light beam NA is set to 0.15 or more and 0.30 or less.

The present invention can provide a fluorescence measurement probe, wherein the excitation light beam NA is 0.15 or more and 0.25 or less.

The present invention can provide a fluorescence measurement probe, wherein the solid light guide path is comprised of an optical fiber, the fiber core diameter of which is 200 μm or more.

According to the present invention, the optical fiber core diameter is set to 200 μm or more. Accordingly, in addition to the above advantage of the present invention, the variation of the received light amount caused by positional misalignment at repeated measurements is suppressed and thus the precision of the repeated measurements is increased.

The present invention can provide a fluorescence measurement probe, wherein the fiber core diameter is 200 μm or more and 300 μm or less.

The present invention can provide a fluorescence measurement probe, wherein the fiber NA of the optical fiber is 0.22 or more.

According to the present invention, the optical fiber NA is set to 0.22 or more. Accordingly, in addition to the above advantage of the present invention, the variation of the received light amount caused by positional misalignment at repeated measurements is suppressed more assuredly and thus the precision of the repeated measurements is increased.

The present invention can provide a fluorescence measurement probe, wherein the fiber NA is 0.22 or more and 0.4 or less.

The present invention can provide a fluorescence measurement probe, wherein the lens is comprised of a curved lens.

The present invention can provide a fluorescence measurement probe, wherein the lens is comprised of a gradient index lens.

The features and advantages of the invention will become more apparent from the following detailed description taken in conjunction with the accompanying drawings.

### BRIEF DESCRIPTION OF THE DRAWINGS

FIGS. 1A and 1B are views useful for explaining the excitation light beam NA.

FIG. 2 is a graph showing the results of experimental example 1-1.

FIGS. 3A to 3D are graphs showing the results of experimental example 1-2.

FIGS. 4A to 4C are graphs showing the results of experimental example 1-3.

FIGS. 5A to 5C are graphs showing the results of experimental example 1-4.

FIGS. 6A to 6C are graphs showing the results of experimental example 1-5.

FIG. 7 is a graph showing the results of experimental examples 1-3 to 1-5 using a ball lens φ 4 mm.

FIG. 8 is a graph showing the results of experimental examples 1-3 to 1-5 using a gradient index lens SLW 18_{—}0.25P.

FIG. 9 is a graph showing the results of experimental examples 1-3 to 1-5 using a gradient index lens SLH 18_{—}0.25P.

FIG. 10 is a graph showing the results of experimental example 2-1.

FIGS. 11A to 11C are graphs showing the results of experimental example 2-2.

FIGS. 12A to 12C are graphs showing the results of experimental example 2-3.

FIGS. 13A to 13C are graphs showing the results of experimental example 2-4.

FIG. 14 is a graph showing the results of experimental examples 2-3 to 2-4 using a ball lens φ 4 mm by adding data of the specimen thickness extended to 2000 μm.

FIG. 15 is a graph showing the results of experimental examples 2-3 to 2-4 using a gradient index lens SLW 18_{—}0.25P by adding data of the specimen thickness extended to 2000 μm.

FIG. 16 is a graph showing the results of experimental examples 2-3 to 2-4 using a gradient index lens SLH 18_{—}0.25P by adding data of the specimen thickness extended to 2000 μm.

FIG. 17 is a block diagram showing a configuration of a conventional fluorescence measurement system.

### DETAILED DESCRIPTION OF THE PREFERRED EMBODIMENTS

Hereinafter, embodiments of the present invention will be described in detail with reference to drawings.

For the fluorescence measurement probe detecting a fluorescent light generated from a specimen onto which an excitation light is radiated, it is very difficult to deterministically determine the conditions for receiving the fluorescent light generated from the specimen with a maximum received light amount because there are a large number of parameters for setting the conditions.

In view of this problem, the applicant introduces a new concept of the excitation light beam NA corresponding to a fiber NA and finds that the fluorescence measurement probe can stably receive the maximum amount of fluorescent light by setting the excitation light beam NA to 0.14 or more and 0.31 or less, thereby reaching the present invention.

Namely, in the present invention, the excitation light beam NA is set to be between 0.14 or more and 0.31 or less.

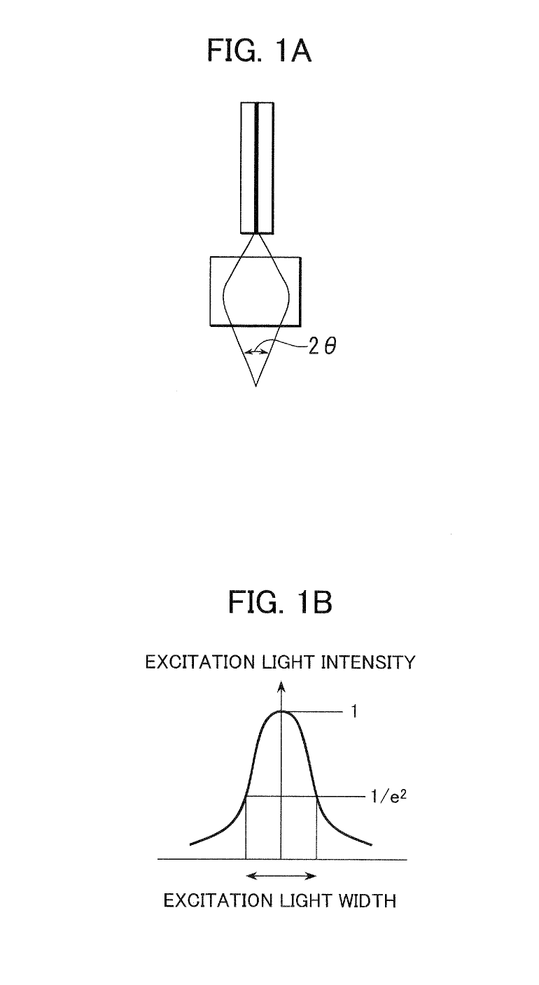

FIGS. 1A and 1B are drawings for explaining the excitation light beam NA. In the present invention, the excitation light beam NA is defined as follows (see FIG. 1A). When an excitation light is emitted from an optical fiber serving as a solid light guide path and is radiated onto a specimen through a lens, the radiation angle of the excitation light is defined as 2θ. At this time, a value expressed by sin θ is defined as the excitation light beam NA. Here, the radiation angle 2θ of the excitation light is defined as follows. The refractive index near a focal point is set to 1 (assume that the specimen is in the air. If the refractive index of the specimen or solvent is different from 1, it is corrected to 1). In addition, the intensity distribution near a focal point of the excitation light is approximated by Gaussian distribution, the position to reach 1/e² of the maximum intensity at a center thereof is determined as an end of the excitation light beam (see FIG. 1B), and the angle 2θ is obtained.

The present inventor has been dedicated to studying the relation between various design conditions and a maximum received light amount in the fluorescence measurement probe. An optical simulation was performed to find an optical system where the maximum received light amount with respect to the specimen thickness was obtained by changing the spacing between the end of an optical fiber serving as a solid light guide path and general ball lens and a gradient index lens, and the optical fiber NA to change the excitation light beam NA in a predetermined range. As a result, the present inventor has found that the excitation light beam NA with a maximum received light amount is in a range 0.14 or more and 0.31 or less.

Hereinafter, the reason why the excitation light beam NA is set 0.14 or more and 0.31 or less will be described in detail.

When the fluorescence measurement probe receives a fluorescent light generated from a specimen which received an excitation light radiation, the parameters for determining the amount of light received include (1) fiber core diameter, (2) fiber NA, (3) type of lens, and (4) thickness of specimen.

### Experimental Example 1

(1) The fiber core diameter was set to practically representative values: 62.5 μm, 100 μm, 200 μm, and 300 μm;

(2) the fiber NA was set to general values: 0.1, 0.22, and 0.4;

(3) the type of lens: representative spherical lens, i.e., ball lens φ 4 mm, gradient index lens SLW 18_{—}0.25P (SELFOC® (registered trademark) MicroLens by Nippon Sheet Glass Company, Ltd), gradient index lens SLH 18_{—}0.25P (SELFOC® (registered trademark) MicroLens by Nippon Sheet Glass Company, Ltd); in every combination of the above conditions,

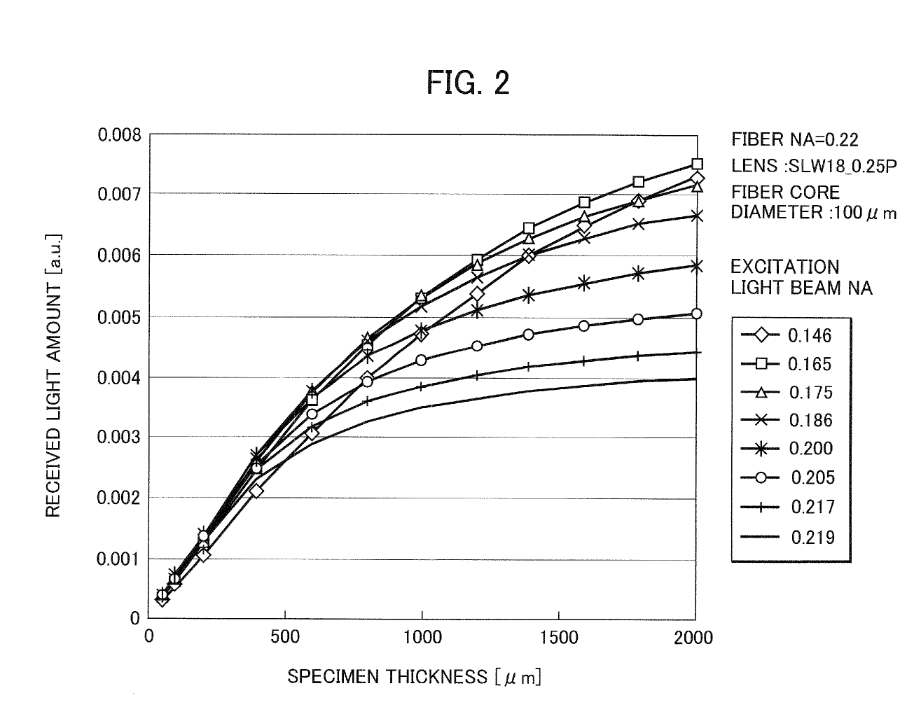

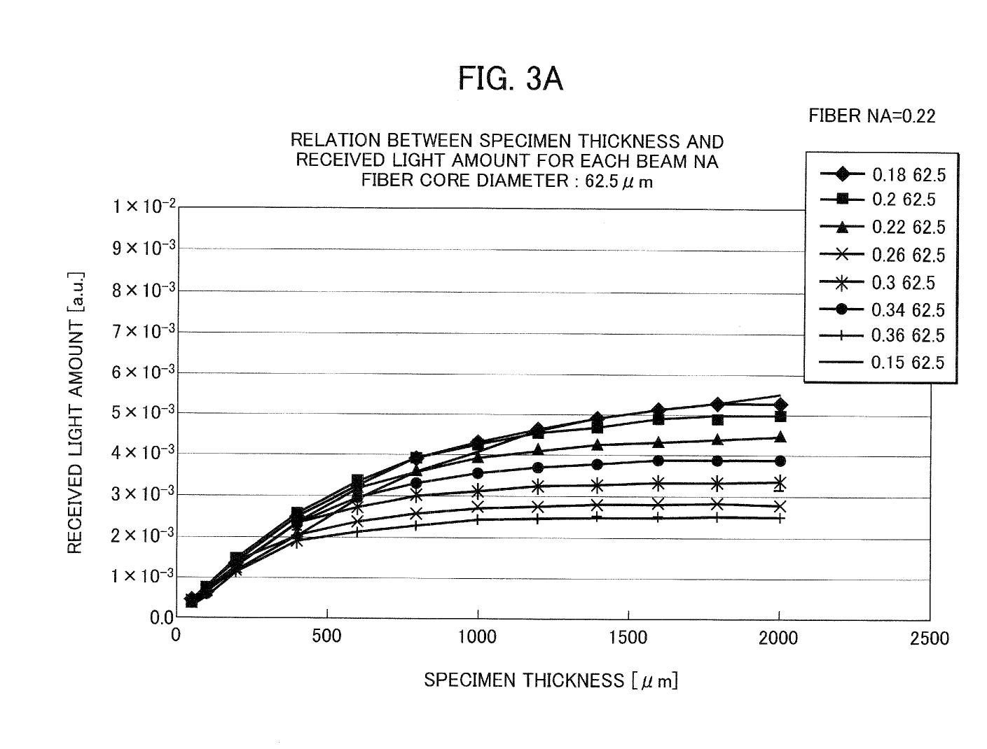

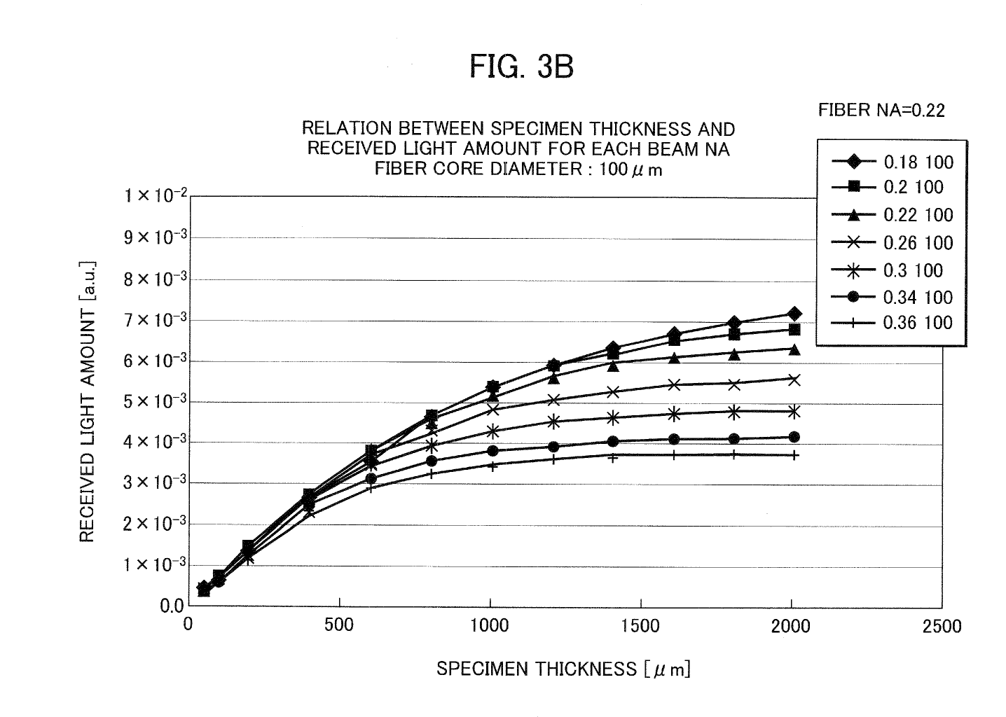

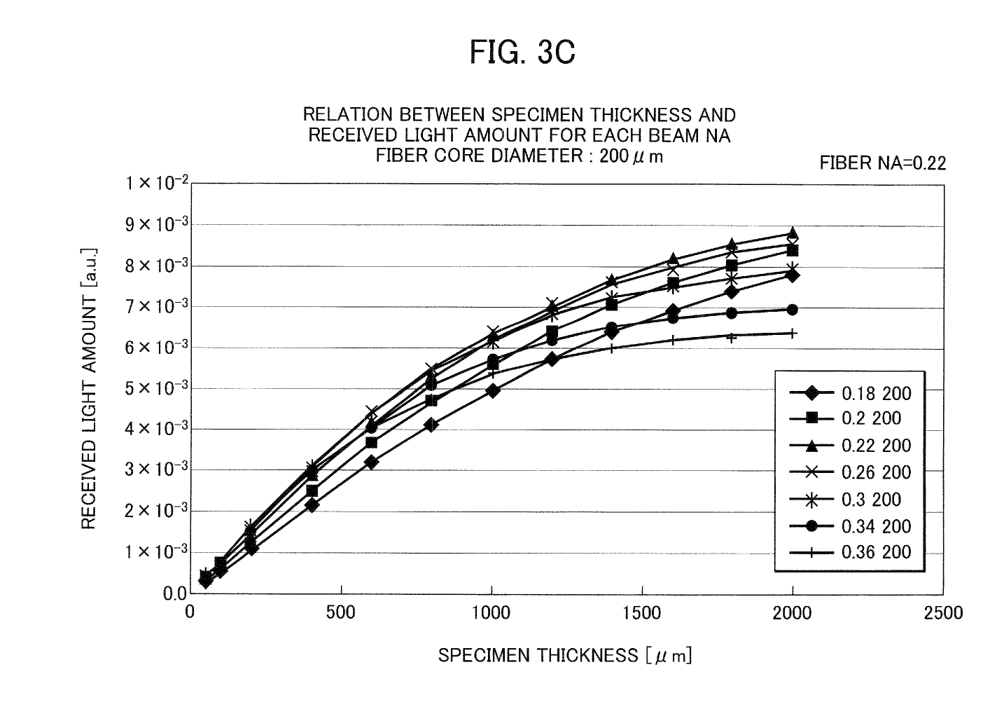

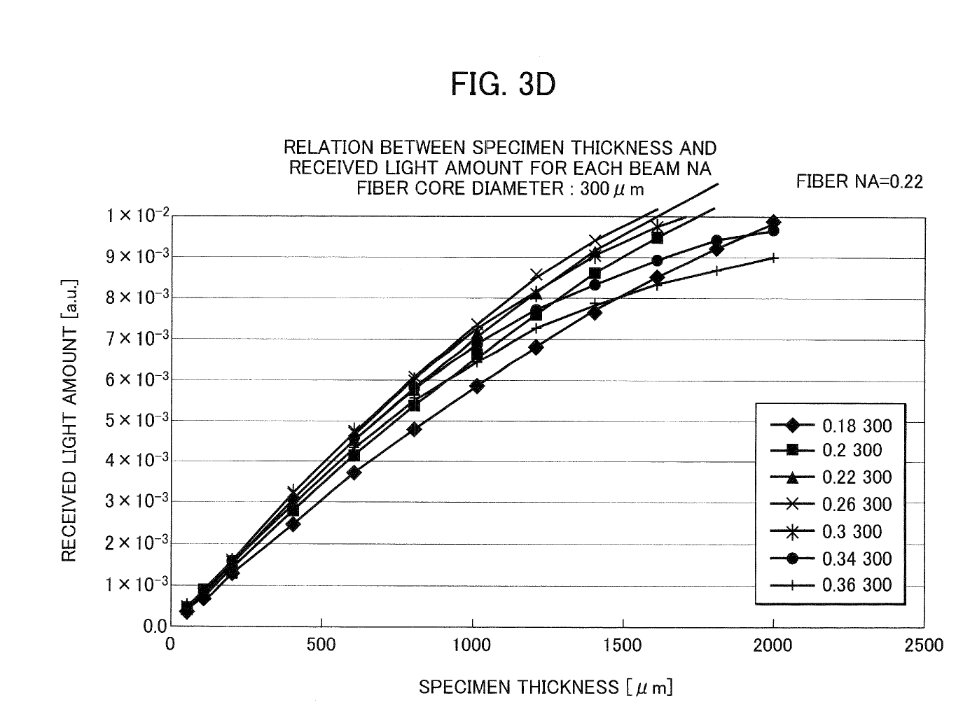

(4) an optical simulation was performed to obtain the change in received fluorescent light amount in a case where the specimen thickness was changed in a practically realistic range from 50 to 2000 μm, and the results were plotted in FIG. 2 and FIGS. 3A to 3D.

FIG. 2 is a graph showing the results of experimental example 1-1. The graph of FIG. 2 shows a change in amount of the fluorescent light received (hereinafter referred to as the received light amount) (a.u.) for each excitation light beam NA with respect to a specimen thickness by setting the fiber NA to 0.22, using a gradient index lens SLW18_{—}0.25P, and setting the fiber core diameter to 100 μm.

FIGS. 3A to 3D are graphs showing the results of experimental example 1-2. In addition to the results of experimental example 1-1, each of the graphs of FIGS. 3A to 3D shows a change in the received light amount for each excitation light beam NA by changing the fiber core diameter to 62.5 μm, 100 μm, 200 μm, and 300 μm respectively.

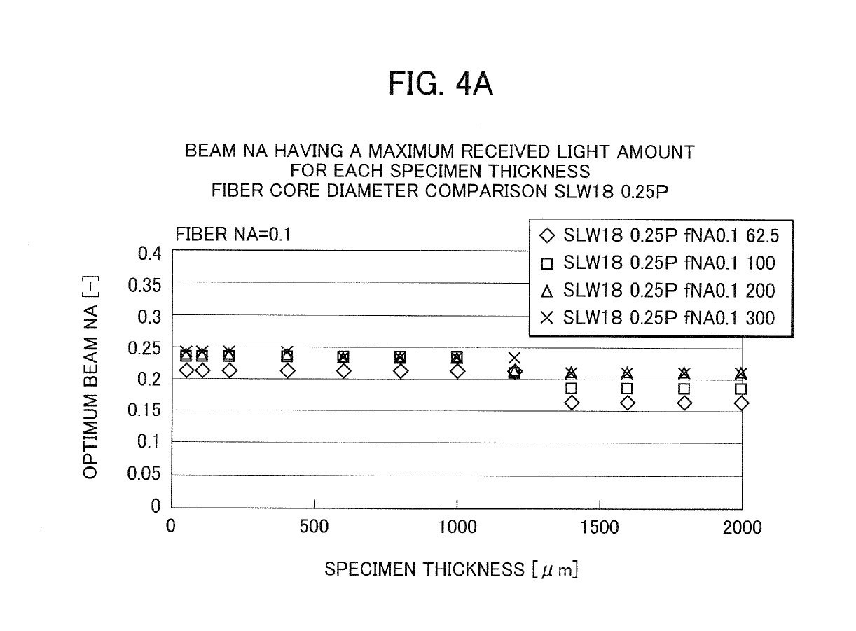

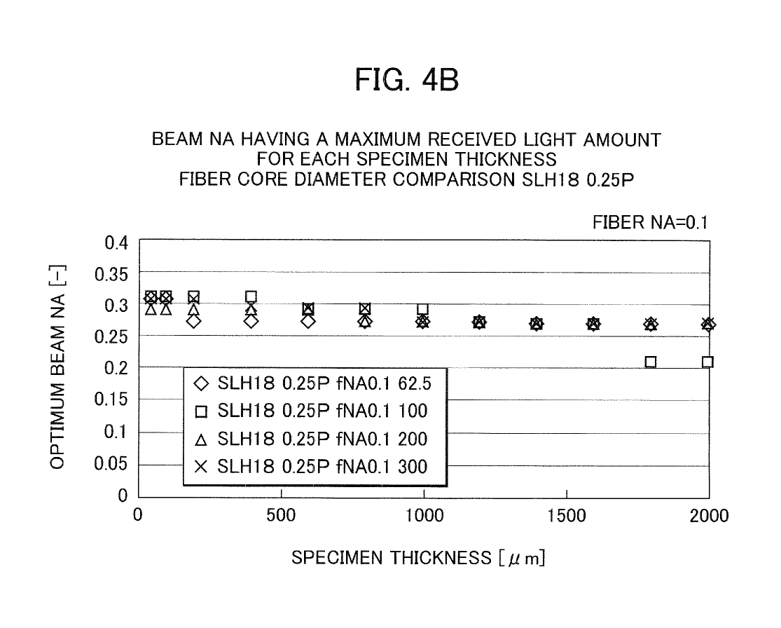

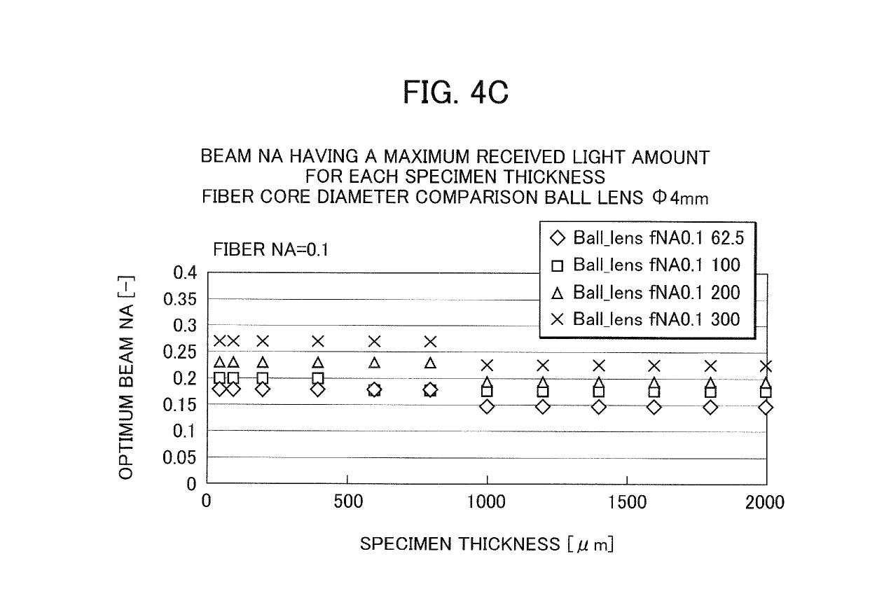

In addition, on the same conditions as the above experimental examples 1-1 and 1-2 except that the lens was changed to a ball lens and a gradient index lens SLH18_{—}0.25P, a change in the received light amount (a.u.) with respect to the specimen thickness was obtained. At the same time, on the same conditions except the fiber NA was changed to 0.1 and 0.4, a change in the received light amount (a.u.) with respect to the specimen thickness was obtained (not shown). Then, from the obtained relation between the specimen thickness and the received light amount (a.u.) of the fluorescent light, the conditions for obtaining an excitation light beam NA having a maximum signal (received light amount) were extracted, which are shown in FIGS. 4A to 4C, FIGS. 5A to 5C, and FIGS. 6A to 6C.

FIGS. 4A to 4C are graphs showing the results of experimental example 1-3. With reference to the graphs of FIGS. 4A to 4C, a gradient index lens SLW18_{—}0.25P, a gradient index lens SLH18_{—}0.25P, and a ball lens φ 4 mm were used as the lens respectively. The fiber NA was set to 0.1, and the fiber core diameter was changed to 62.5 μm, 100 μm, 200 μm, and 300 μm, and the specimen thickness was changed in a range from 50 to 2000 μm. Then, an optimum excitation light beam NA having a maximum signal for each specimen thickness was extracted and plotted on the individual graphs.

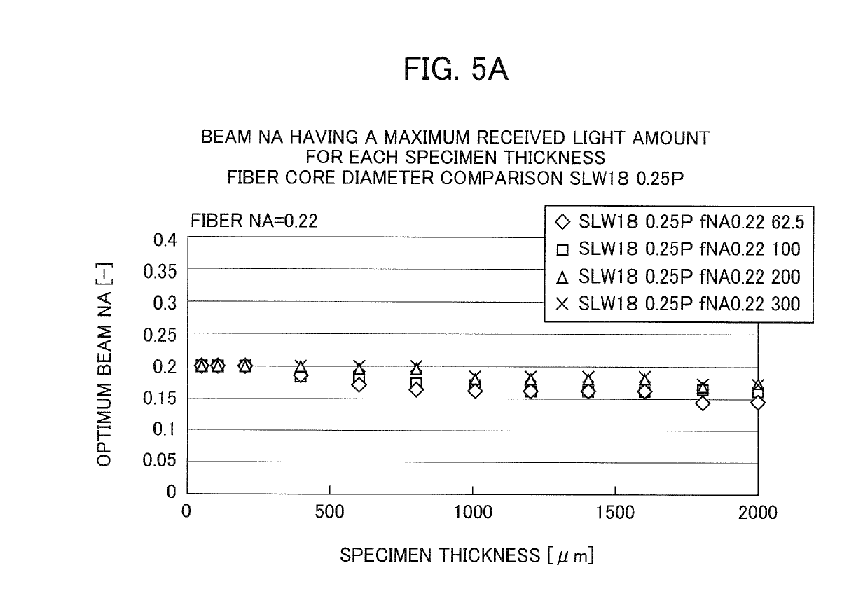

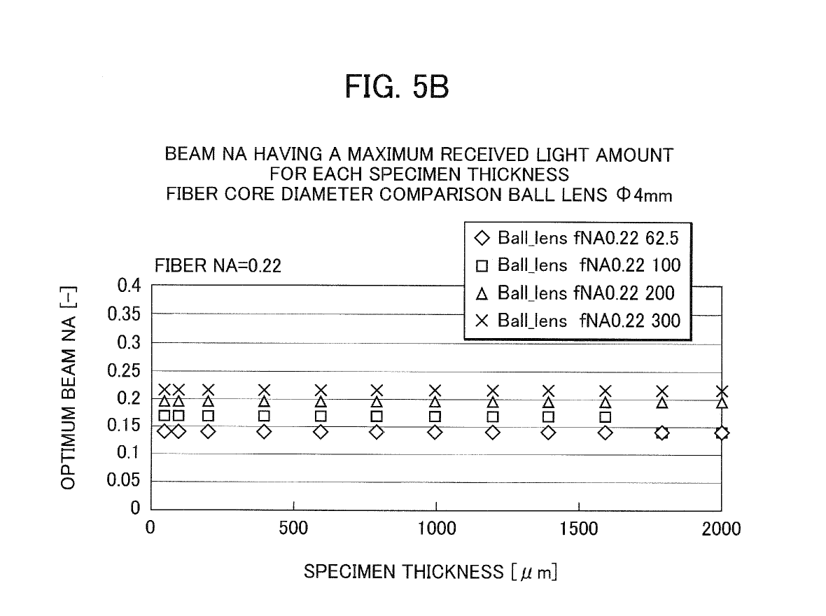

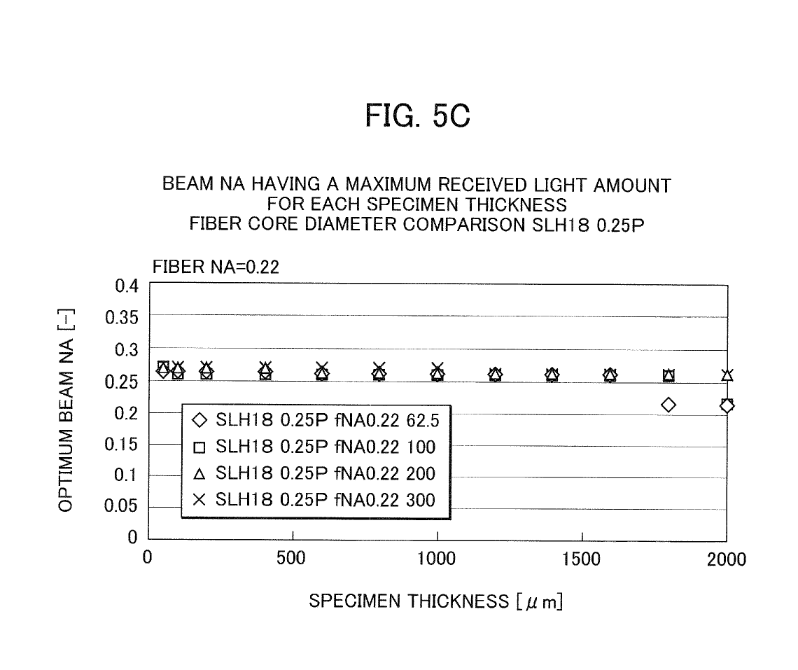

FIGS. 5A to 5C are graphs showing the results of experimental example 1-4. With reference to the graphs of FIGS. 5A to 5C, on the same conditions as the above experimental examples 1-3 shown in FIGS. 4A to 4C except that fiber NA was set to 0.22, an optimum excitation light beam NA having a maximum signal was extracted and plotted on the individual graphs.

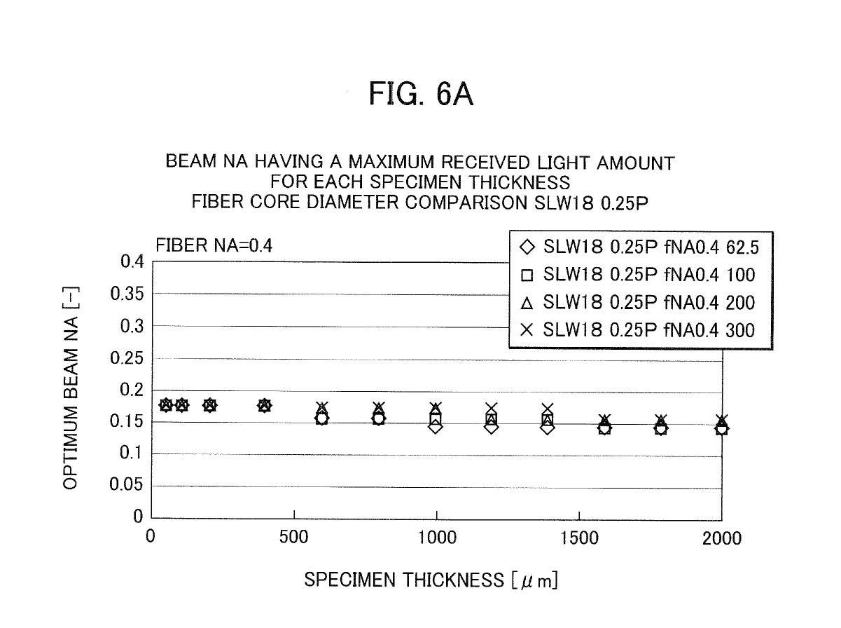

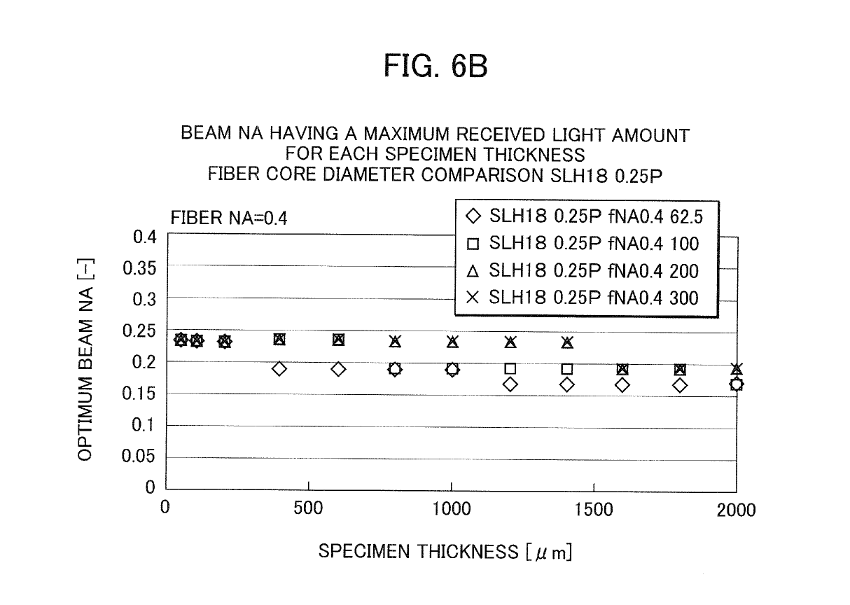

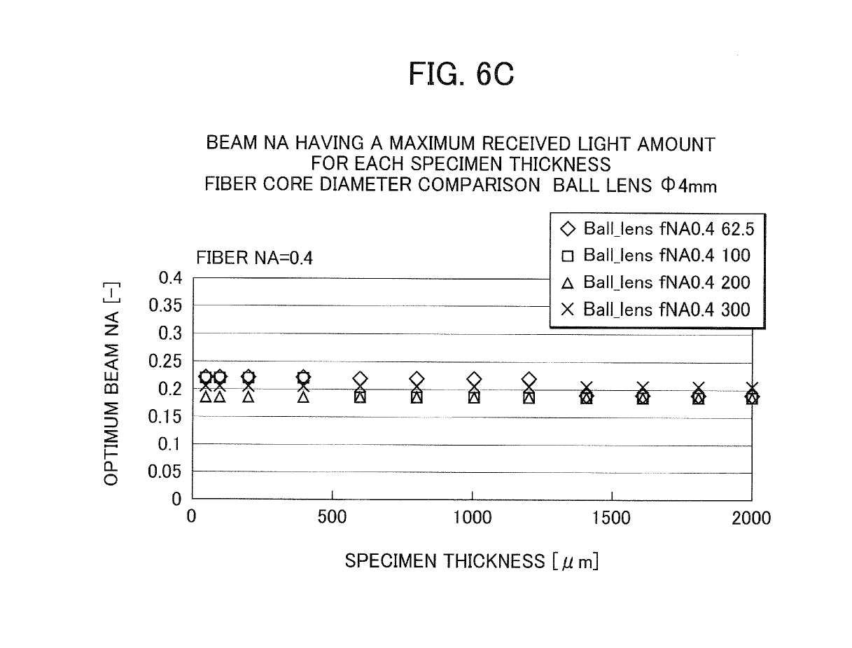

FIGS. 6A to 6C are graphs showing the results of experimental example 1-5. With reference to the graphs of FIGS. 6A to 6C, on the same conditions as the above experimental examples 1-3 shown in FIGS. 4A to 4C except that fiber NA was set to 0.4, an optimum excitation light beam NA having a maximum signal was extracted and plotted on the individual graphs.

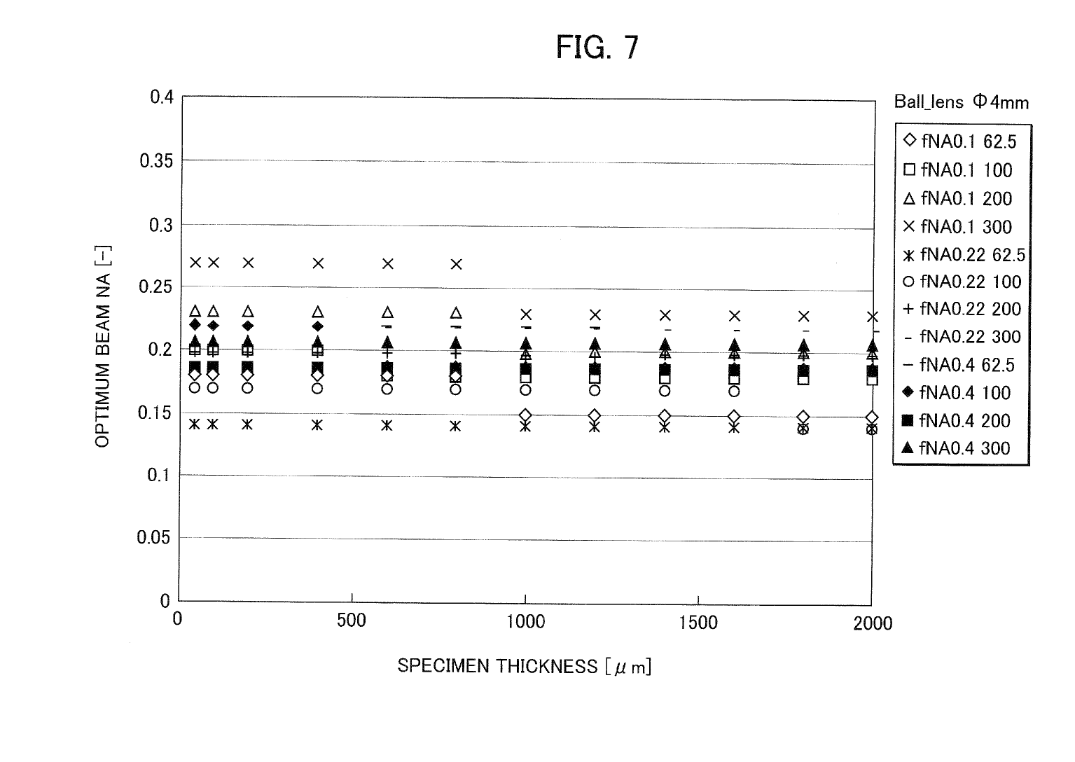

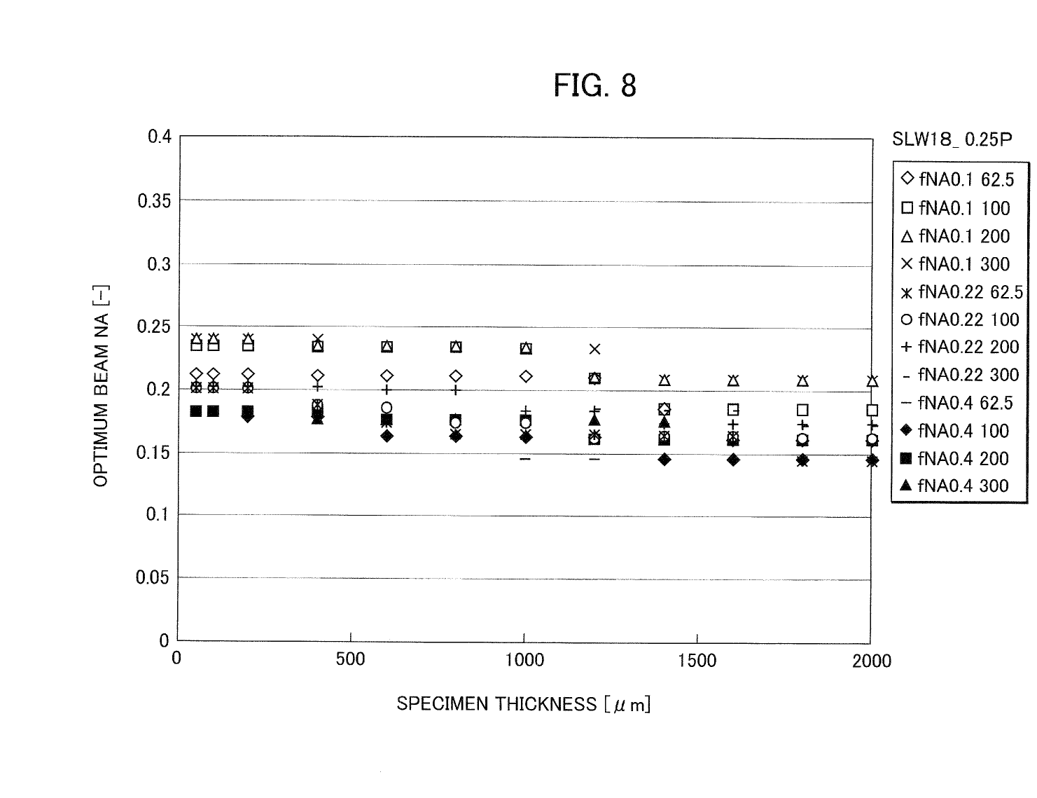

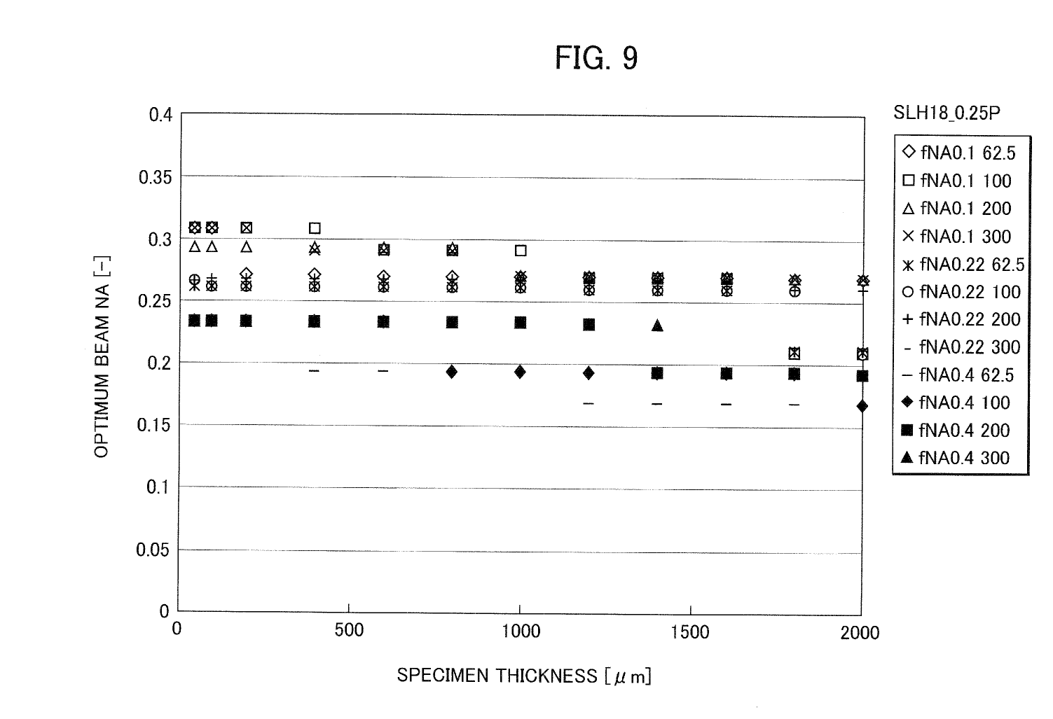

FIG. 7 is a graph showing the results of experimental examples shown in FIGS. 4A to 4C, FIGS. 5A to 5C, and FIGS. 6A to 6C using a ball lens φ 4 mm. FIG. 8 is a graph showing the results of experimental examples shown in FIGS. 4A to 4C, FIGS. 5A to 5C, and FIGS. 6A to 6C using a gradient index lens SLW 18_{—}0.25P. FIG. 9 is a graph showing the results of experimental examples shown in FIGS. 4A to 4C, FIGS. 5A to 5C, and FIGS. 6A to 6C using a gradient index lens SLH 18_{—}0.25P.

With reference to FIGS. 7 to 9, it is understood that the fluorescence measurement probe having a maximum signal was obtained regardless of the fiber core diameter, the fiber NA, the lens type, and the specimen thickness as long as the excitation light beam NA is set to 0.14 or more and 0.31 or less.

Accordingly, the present invention sets the excitation light beam NA to 0.14 or more and 0.31 or less.

### Experimental Example 2

Even in a case satisfying the conditions of the excitation light beam NA obtained by the experimental example 1, a good signal may not be obtained due to a change in distance from the lens surface to the specimen surface (hereinafter referred to as the lens-specimen distance), or reproducibility may be reduced due to positional misalignment when the specimen is replaced.

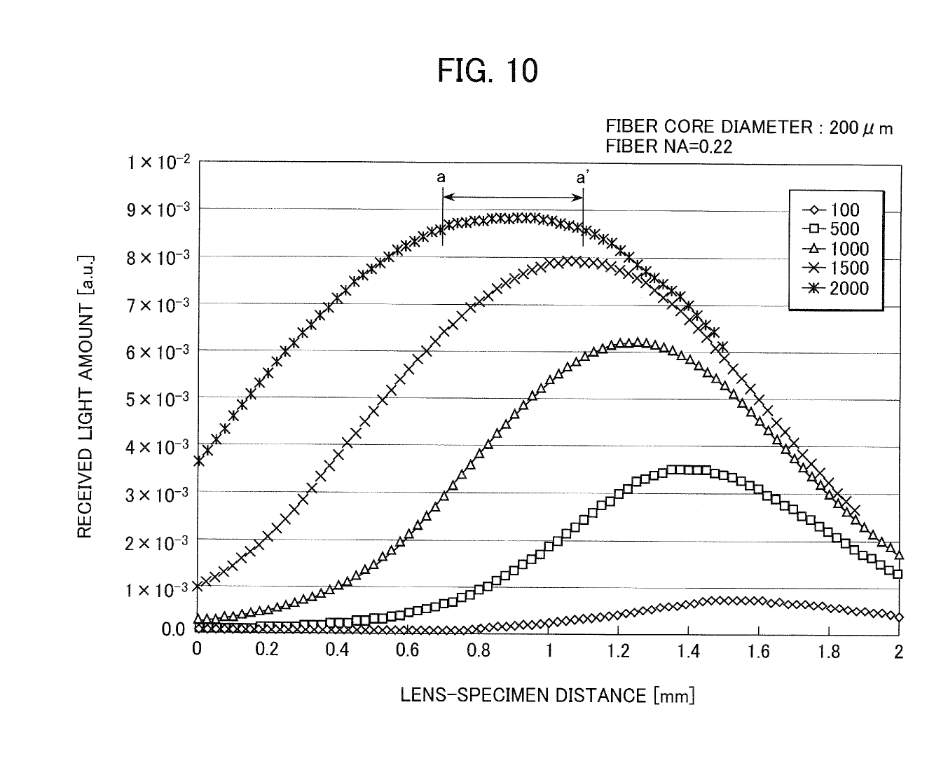

FIG. 10 is a graph showing the results of experimental example 2-1. The graph of FIG. 10 shows a change in amount of received light amount (a.u.) with respect to lens-specimen distance ranging from 50 μm to 2 mm, using a gradient index lens SLW18_{—}0.25P, and setting the fiber core diameter to 200 μm, the fiber NA to 0.22, and the specimen thickness to 100 μm, 500 μm, 1000 μm, 1500 μm, and 2000 μm.

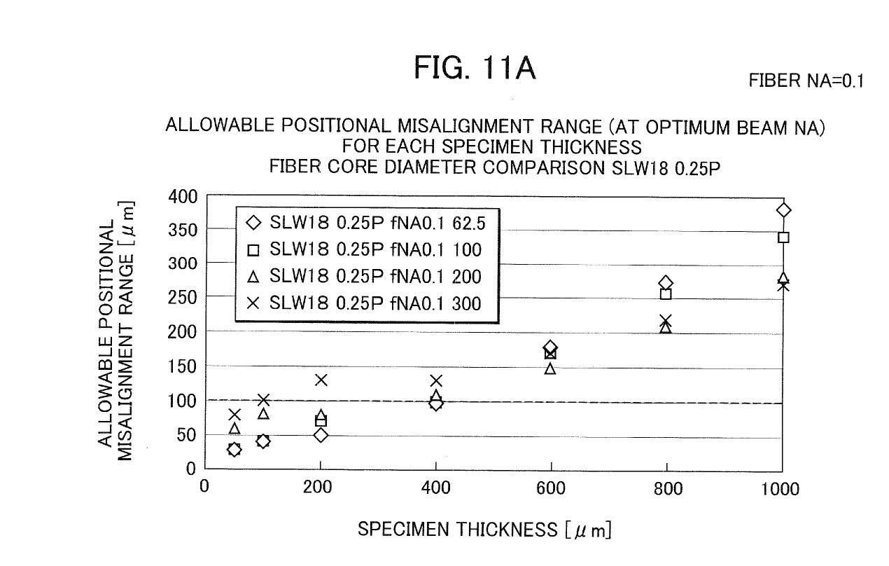

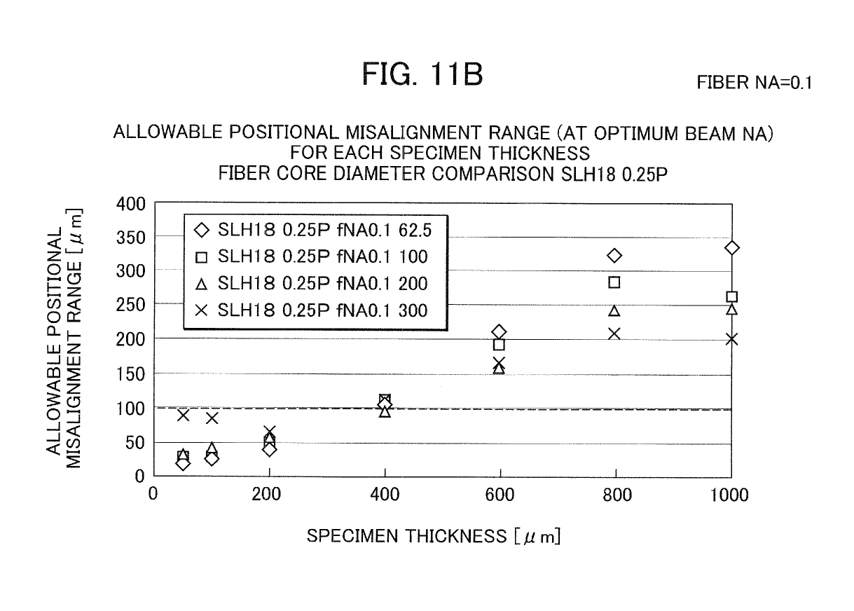

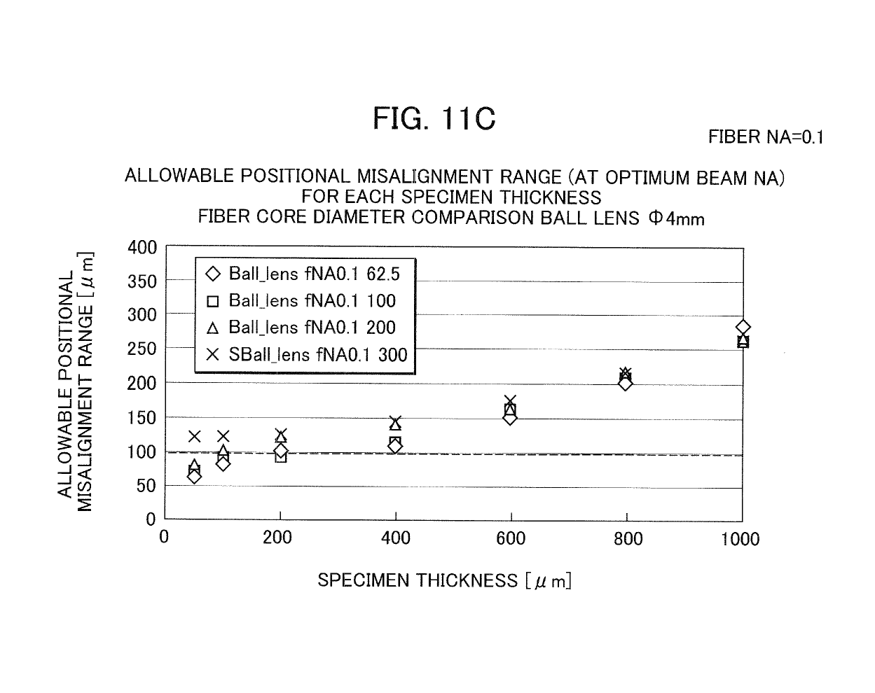

In general, the measurement variation required for a measuring device used for measurement in a micro area is ±5% or less. With that in mind, in a curve of the specimen thickness of 2000 μm shown in FIG. 10, the reproducibility for the measuring device was defined to be satisfied if a received light amount within the range (a-a′), i.e., ±5% of the maximum received light amount is repeatedly obtained. Then, tests were made to find the relation between the specimen thickness and the positional misalignment width (allowable positional misalignment range) at specimen replacement which can obtain the received light amount within ±5% of the maximum received light amount required to satisfy the reproducibility. The test results are shown in FIGS. 11 to 13.

FIGS. 11A to 11C are graphs showing the results of experimental example 2-2. With reference to the graphs of FIGS. 11A to 11C, the fiber NA was set to 0.1 and the fiber core diameter was changed to 62.5 μm, 100 μm, 200 μm, and 300 μm, then, an allowable positional misalignment range with respect to the specimen thickness was plotted for each lens.

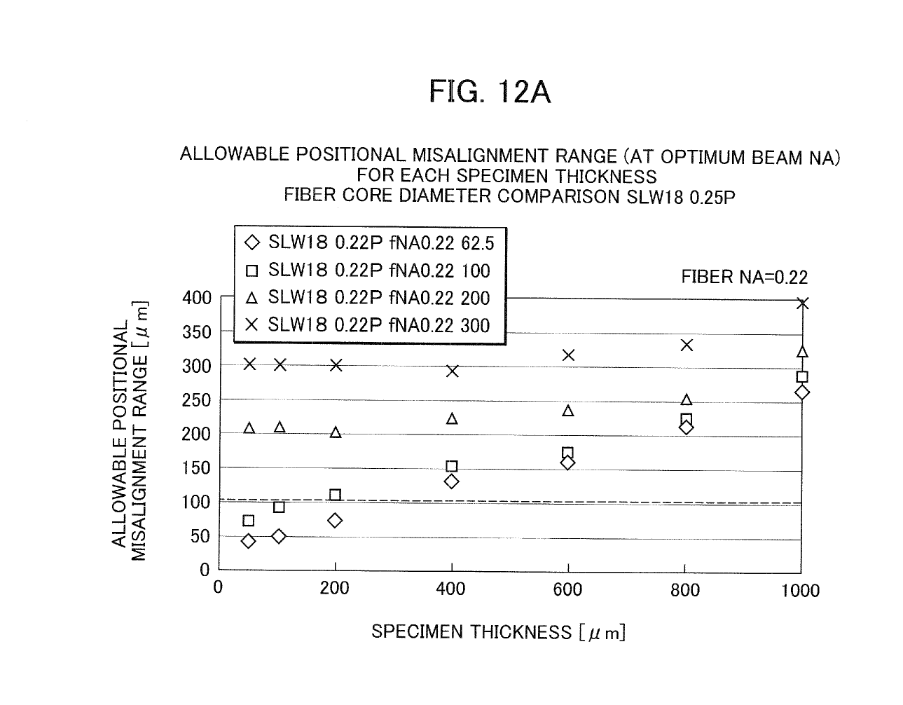

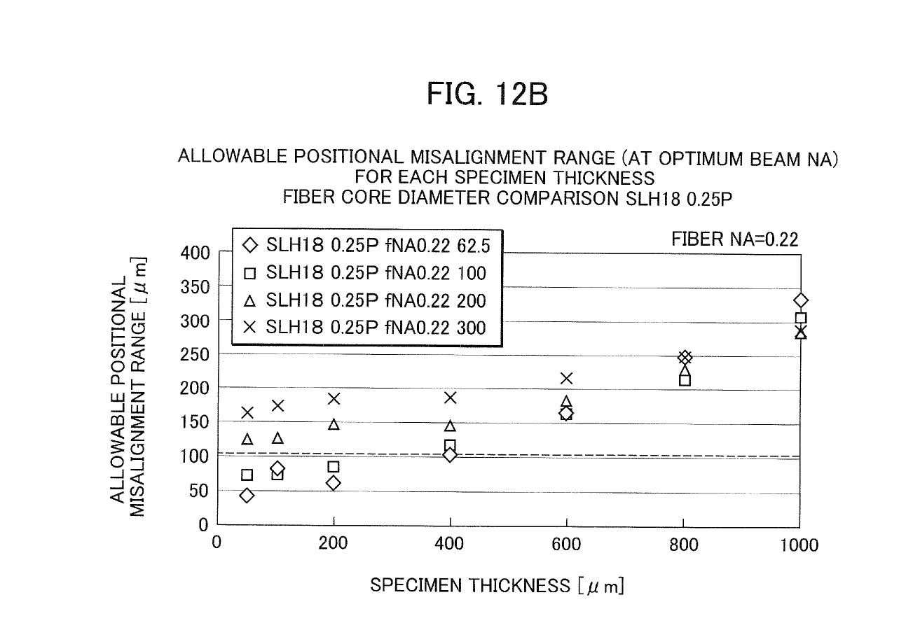

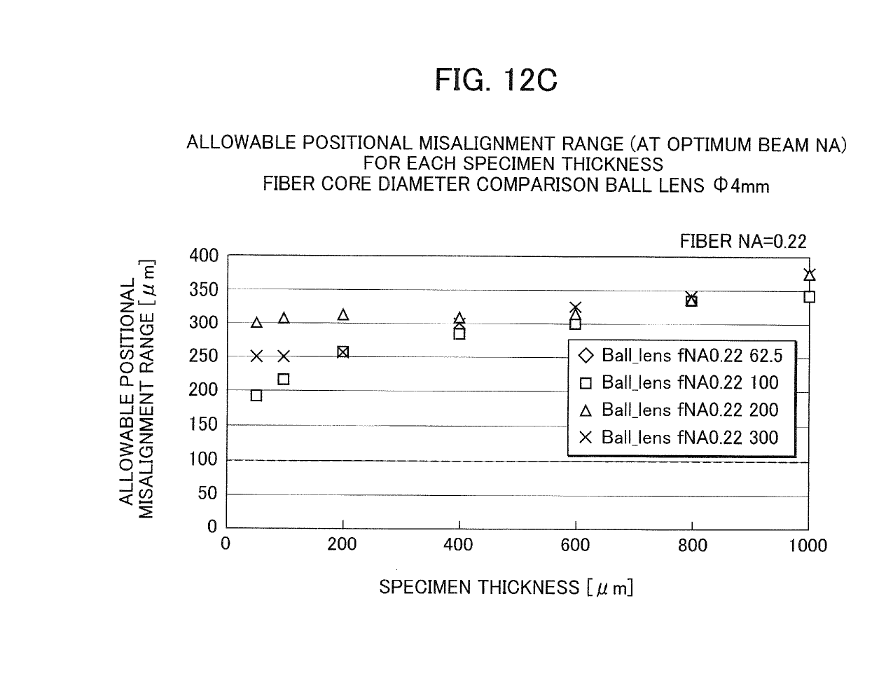

FIGS. 12A to 12C are graphs showing the results of experimental example 2-3. With reference to the graphs of FIGS. 12A to 12C, on the same conditions as the above experimental examples 2-2 shown in FIGS. 11A to 11C except that the fiber NA was set to 0.22, an allowable positional misalignment range with respect to the specimen thickness was plotted for each lens.

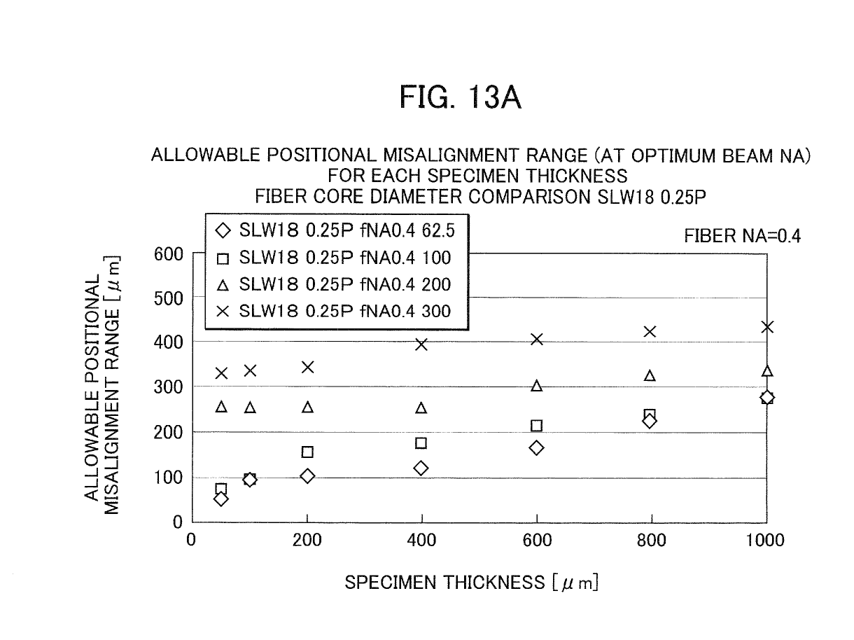

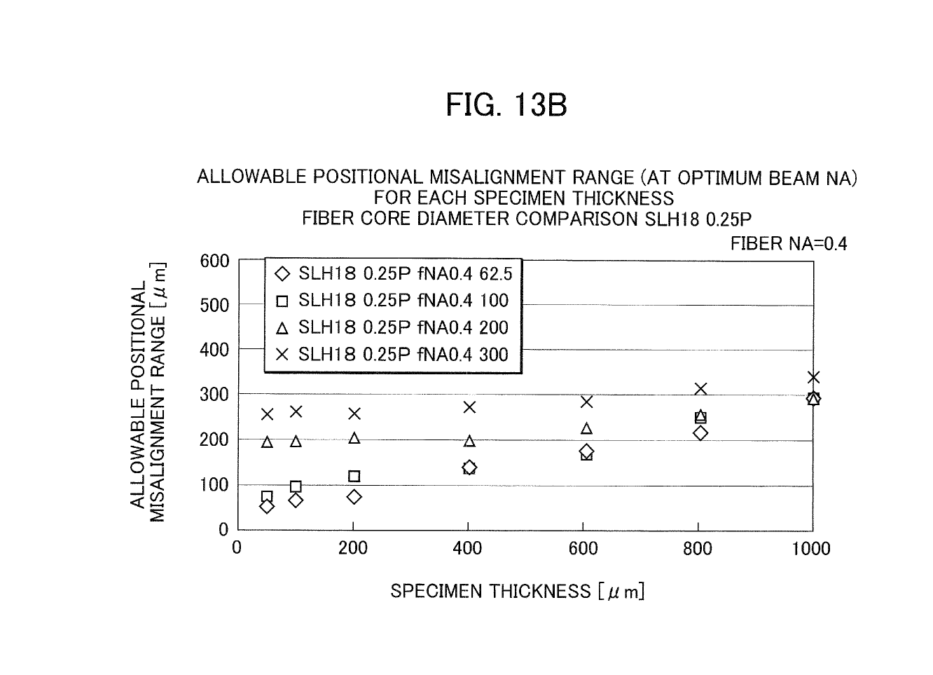

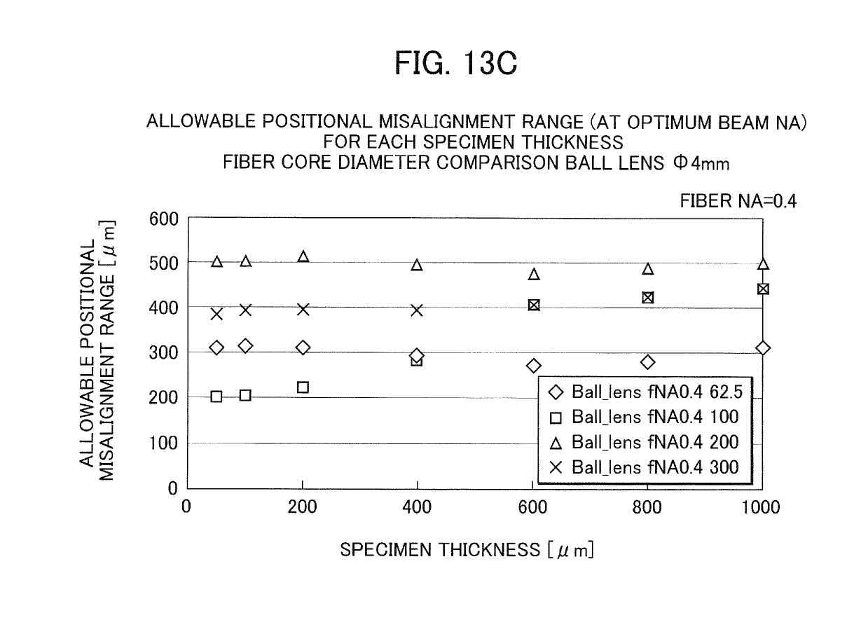

FIGS. 13A to 13C are graphs showing the results of experimental example 2-4. With reference to the graphs of FIGS. 13A to 13C, on the same conditions as the above experimental examples 2-2 shown in FIGS. 11A to 11C except that the fiber NA was set to 0.4, an allowable positional misalignment range with respect to the specimen thickness was plotted for each lens.

Here, if the positional misalignment range for repeated settings for specimen replacement is set to a practical 100 μm (refer to JIS-B0405: general tolerances), and the allowable positional misalignment range 100 μm or less for satisfying the reproducibility of the measuring device is excluded, some fibers NA set to 0.1 shown in FIGS. 11A to 11C (experimental example 2-2) do not satisfy the allowable positional misalignment amount of all fiber core diameters. Therefore, according to the present invention, the fiber NA is preferably set to 0.22 or more from the point of view for maintaining reproducibility.

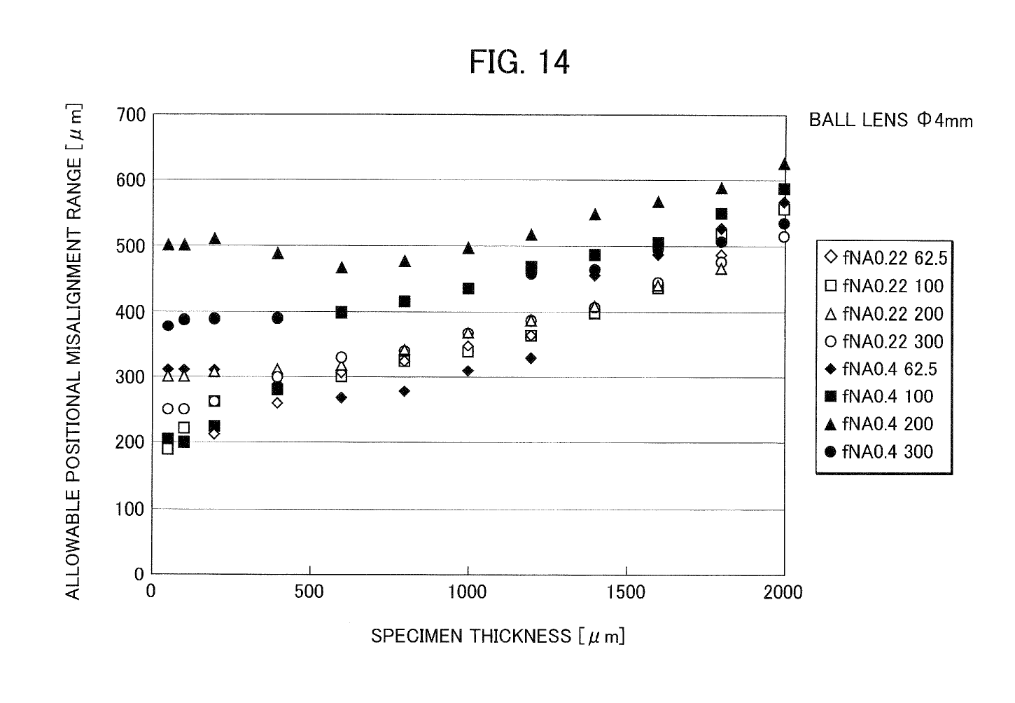

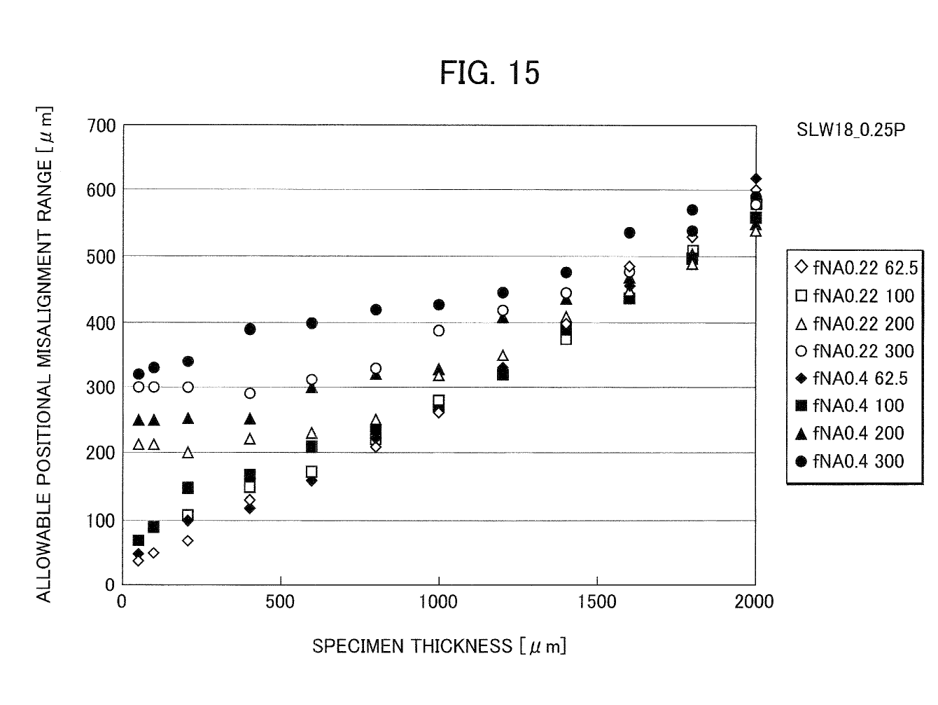

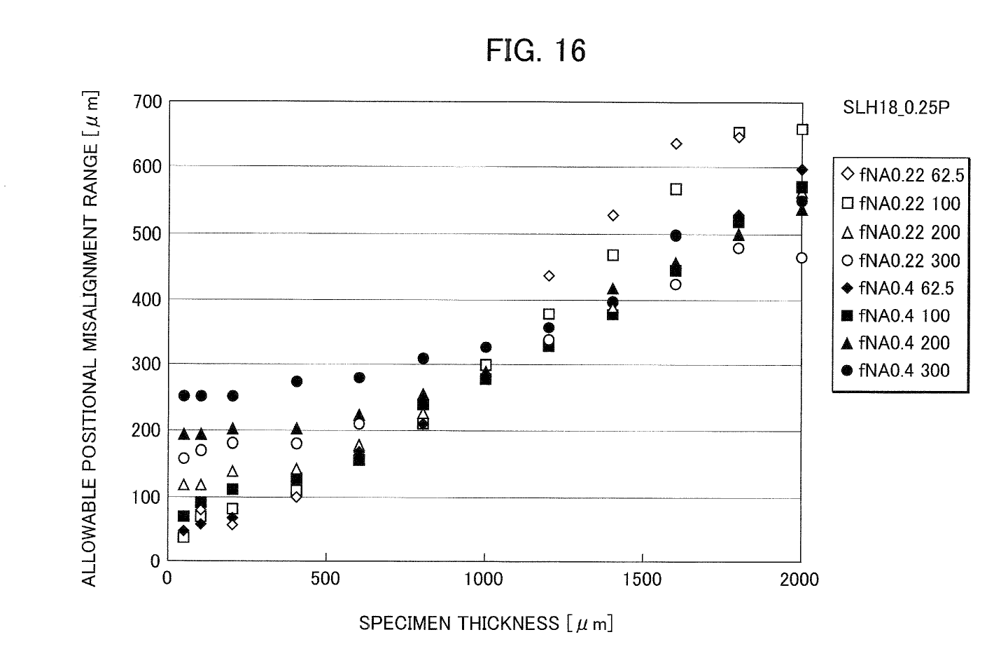

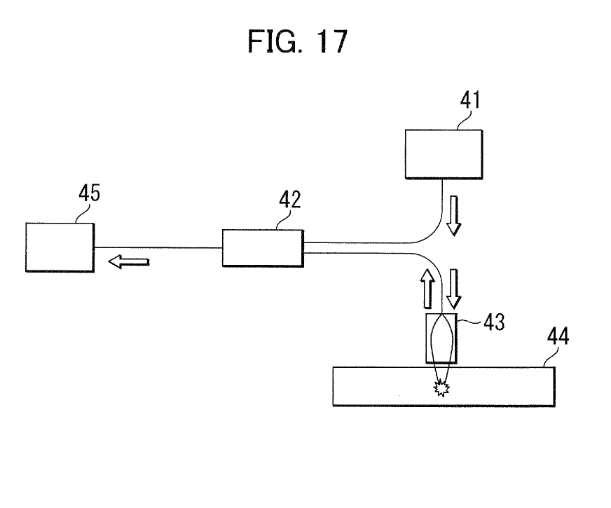

FIG. 14 is a graph showing the results of experimental examples shown in FIGS. 12A to 12C and FIGS. 13A to 13C using a ball lens φ 4 mm by adding the range of specimen thickness extended to 2000 μm. Here, a ball lens was used for calculation, but a drum lens produced by grinding lateral faces of the ball lens may be used to obtain the same result. FIG. 15 is a graph showing the results of experimental examples shown in FIGS. 12A to 12C and FIGS. 13A to 13C using a gradient index lens SLW 18_{—}0.25P by adding the range of the thickness of the specimen extended to 2000 μm. FIG. 16 is a graph showing the results of experimental examples shown in FIGS. 12A to 12C and FIGS. 13A to 13C using a gradient index lens SLH 18_{—}0.25P by adding the range of the thickness of the specimen extended to 2000 μm.

With reference to FIGS. 14 to 16, it is understood that the allowable positional misalignment range 100 μm is satisfied for all by setting the fiber core diameter to 200 μm or more. Therefore, according to the present invention, the fiber core diameter is set to 200 μm or more and the fiber NA is set to 0.22 or more for maintaining reproducibility.

### Example 1

The fluorescence measurement probe having good detection sensitivity and high repetitive accuracy was obtained by using a ball lens φ 4 mm as a representative curved lens, and setting the excitation light beam NA to 0.15 to 0.25 and the fiber NA to 0.22.

### Example 2

The fluorescence measurement probe having good detection sensitivity and high repetitive accuracy was obtained by using a gradient index lens SLW18_{—}0.25P, and setting the excitation light beam NA to 0.15 to 0.25, the fiber NA to 0.22 and the fiber core diameter to 200 μm.

### Example 3

The fluorescence measurement probe having good detection sensitivity was obtained by using a ball lens φ 4 mm as a representative curved lens and setting the excitation light beam NA to 0.15 to 0.25.

What is claimed is:

1. A fluorescence measurement probe which is applied to a fluorescence measurement system provided with an optical system having a light source emitting an excitation light and a detector receiving a fluorescent light generated from a specimen onto which said excitation light is radiated, comprising:
a solid light guide path adopted to serve as an optical path of said excitation light as well as an optical path of said fluorescent light;
a lens disposed between an edge surface of said solid light guide path and said specimen; wherein
when a radiation angle of said excitation light is set to 2θ at a position where the excitation light is collected by said lens which collects the fluorescent light generated from said specimen receiving the excitation light which is emitted from said solid light guide path and radiated through said lens, an excitation light beam NA expressed by sin θ is set to 0.14 or more and 0.31 or less.

2. The fluorescence measurement probe according to claim 1, wherein said excitation light beam NA is set to 0.15 or more and 0.30 or less.

3. The fluorescence measurement probe according to claim 2, wherein said excitation light beam NA is 0.15 or more and 0.25 or less.

4. The fluorescence measurement probe according to claim 1, wherein said solid light guide path is comprised of an optical fiber, the fiber core diameter of which is 200 μm or more.

5. The fluorescence measurement probe according to claim 4, wherein said fiber core diameter is 200 μm or more and 300 μm or less.

6. The fluorescence measurement probe according to claim 4, wherein the fiber NA of said optical fiber is 0.22 or more.

7. The fluorescence measurement probe according to claim 6, wherein said fiber NA is 0.22 or more and 0.4 or less.

8. The fluorescence measurement probe according to claim 1, wherein said lens is comprised of a curved lens.

9. The fluorescence measurement probe according to claim 1, wherein said lens is comprised of a gradient index lens.
